(19) United States
(12) Patent Application Publication
(10) Pub. No.: US 2023/0092424 A1
(43) Pub. Date: Mar. 23, 2023

(54) MULTIFREQUENCY OPERATION FOR INTEGRATED ACCESS AND BACKHAUL

(71) Applicant: AT&T Intellectual Property I, L.P., Atlanta, GA (US)

(72) Inventor: Thomas Novlan, Jonestown, TX (US)

(21) Appl. No.: 17/480,582

(22) Filed: Sep. 21, 2021

(51) Int. Cl. H04W 72/04; H04W 72/10; H04W 72/12; H04W 88/14

(52) U.S. Cl. CPC H04W 72/0426; H04W 72/0453; H04W 72/10; H04W 72/1263; H04W 88/14

(57) ABSTRACT

The technology is generally directed towards configuring, coordinating, and operating across multiple frequency carriers or bands on one or more access and backhaul links. An integrated access and backhaul (e.g., child) node, for example, determines first multiplexing capability data representative of a first multiplexing capability for a first frequency resource, and determines second multiplexing capability data representative of a second multiplexing capability for a second frequency resource. The first and second multiplexing capability data for the first and second resources are communicated to a second (e.g., parent) integrated access and backhaul node. Quality of service can be applied across multiple frequency carriers utilized by the integrated access and backhaul node for access and backhaul links. Also described is supporting multifrequency operation outside of the radio access network for non-new radio-based traffic backhauling.

### TECHNICAL FIELD

The subject application is related to wireless communication systems, and, for example, to the configuration, coordination, and operation for multifrequency integrated access and backhaul (IAB) networks, and related embodiments.

### BACKGROUND

Due to the larger bandwidth available for New Radio (NR, e.g., in the mmWave spectrum) compared to LTE along with the native deployment of massive MIMO (Multiple-Input Multiple-Output) or multi-beam systems in NR, integrated access and backhaul (IAB) links can be developed and deployed. This may, for example, allow easier deployment of a dense network of self-backhauled NR cells in a more integrated manner by building upon many of the control and data channels/procedures defined for providing access to user equipment (UE). In general, IAB nodes (e.g., nodes B and C) multiplex access (mobile terminal/e.g., user equipment) and backhaul (distributed unit/e.g., access point) links in time, frequency, and/or space (e.g., beam-based operation), to relay user traffic to a donor or parent IAB node (e.g., a node A), and vice-versa.

IAB nodes can support multifrequency operation (e.g., frequency division multiplexing, or 1-DM) on one or more frequency carriers or bands. There is thus a need to configure, coordinate, and operate across multiple frequency carriers or bands on one or more access and backhaul links.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system in which integrated access and backhaul (IAB) nodes are hierarchically arranged, including with a child IAB node having multiple parent IAB nodes, and in which one parent node receives multifrequency data including multiplexing capability data from a child node, in accordance with various aspects and embodiments of the subject disclosure.

FIG. 2 illustrates multifrequency operation of an IAB node, in accordance with various aspects and embodiments of the subject disclosure.

FIG. 3 illustrates a child IAB node sending multifrequency data including multiplexing capability information to a parent node, in which the communication includes usage criterion data, in accordance with various aspects and embodiments of the subject disclosure.

FIG. 4 illustrates a child IAB node sending multifrequency data including multiplexing capability information and QoS-related information to a parent node, in which the communication includes usage criterion data, in accordance with various aspects and embodiments of the subject disclosure.

FIG. 5 illustrates a child IAB node sending multifrequency data including multiplexing capability information and QoS-related information to a non-new radio traffic source, in accordance with various aspects and embodiments of the subject disclosure.

FIG. 6 is a flow diagram showing example operations related to communicating first and second multiplexing capability data associated with respective first and second frequency resources between IAB nodes, in accordance with various aspects and embodiments of the subject disclosure.

FIG. 7 is a flow diagram showing example operations related to communicating respective multiplexing capability data for respective frequency resources from a child IAB node to a parent IAB node, in accordance with various aspects and embodiments of the subject disclosure.

FIG. 8 is a flow diagram showing example operations related to an IAB node communicating backhaul traffic via first and second frequency resources and communicating access traffic via the first frequency resource and a third frequency resources, in accordance with various aspects and embodiments of the subject disclosure.

FIG. 9 illustrates an example block diagram of an example user equipment that can be a mobile handset in accordance with various aspects and embodiments of the subject disclosure.

FIG. 10 illustrates an example block diagram of a computer that can be operable to execute processes and methods in accordance with various aspects and embodiments of the subject disclosure.

### DETAILED DESCRIPTION

Various aspects of the technology described herein are directed towards the configuration, coordination, and operation for multifrequency IAB networks. For example, to support multifrequency operation (e.g. frequency division multiplexing, or FDM) on one or more frequency carriers or bands, configuration and coordination within the IAB node between the IAB-DU and IAB-MT function is performed, depending on the IAB node physical layer capabilities, via the technology described herein. Configuration and coordination with one or more parent backhaul links is also performed via the technology described herein, because different frequency carriers and bands can have different requirements and capabilities to support access and or backhaul links.

It also should be understood that any of the examples and terms used herein are non-limiting. For instance, the examples are based on New Radio (NR, sometimes referred to as 5G) communications between a user equipment exemplified as a smartphone or the like and network device; however virtually any communications devices (user and network) including 6G and beyond may benefit from the technology described herein. Thus, any of the embodiments, aspects, concepts, structures, functionalities or examples described herein are non-limiting, and the technology may be used in various ways that provide benefits and advantages in radio communications in general.

In some embodiments the non-limiting term “radio network node” or simply “network node,” “radio network device or simply “network device” is used herein. These terms may be used interchangeably, and refer to any type of network node that serves user equipment and/or connected to other network node or network element or any radio node from where user equipment receives signal. Examples of radio network nodes are Node B, base station (BS), multi-standard radio (MSR) node such as MSR BS, gNodeB, eNode B, network controller, radio network controller (RNC), base station controller (BSC), relay, donor node controlling relay, base transceiver station (BTS), access point (AP), transmission points, transmission nodes, RRU, RRH, nodes in distributed antenna system (DAS) etc.

In some embodiments the non-limiting term user equipment (UE) is used. It refers to any type of wireless device that communicates with a radio network node in a cellular or mobile communication system. Examples of user equipment are target device, device to device (D2D) user equipment, machine type user equipment or user equipment capable of machine to machine (M2M) communication, PDA, Tablet, mobile terminals, smart phone, laptop embedded equipped (LEE), laptop mounted equipment (LME), USB dongles etc.

Some embodiments are described in particular for 5G new radio systems. The embodiments are however applicable to any radio access technology (RAT) or multi-RAT system where the user equipment operates using multiple carriers e.g. LTE FDD/TDD, WCMDA/HSPA, GSM/GERAN, Wi Fi, WLAN, WiMax, CDMA2000 etc.

The embodiments are applicable to single carrier as well as to multicarrier (MC) or carrier aggregation (CA) operation of the user equipment. The term carrier aggregation (CA) is also called (e.g. interchangeably called) “multi-carrier system”, “multi-cell operation”, “multi-carrier operation”, “multi-carrier” transmission and/or reception. Note that the solutions outlined applies for Multi RAB (radio bearers) on some carriers (that is data plus speech is simultaneously scheduled).

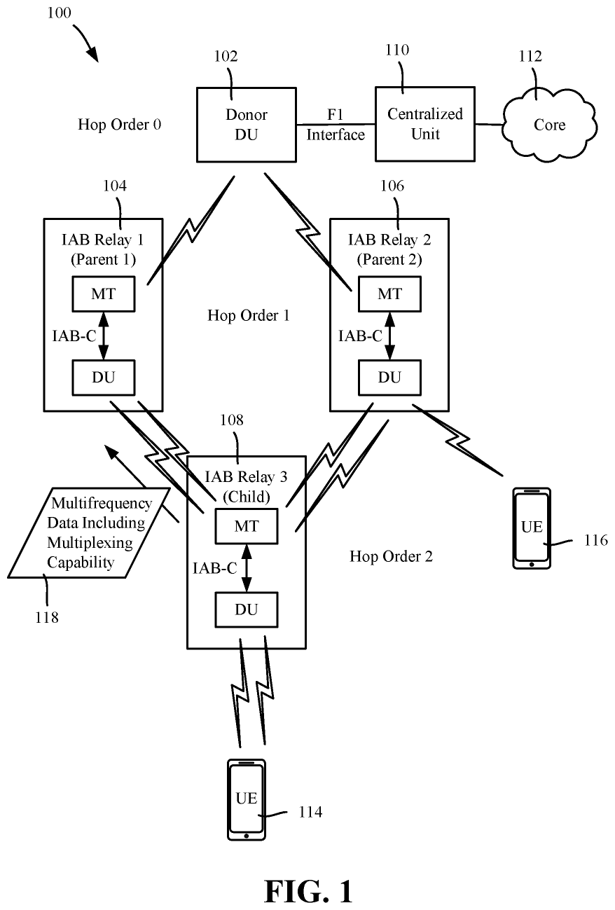

FIG. 1 illustrates an example wireless communication system 100 comprising a multiple hop (multi-hop) integrated access and backhaul network in accordance with various aspects and embodiments of the subject technology. As shown in FIG. 1, the design of a multi-hop IAB network according to the 3rd Generation Partnership Project (3GPP) standards is based on a hierarchical concept that allows use of existing access downlink (DL) and uplink (UL) procedures and channels to create a multi-hop network. This is arranged by having a donor node 102 (at hop order 0), comprising a distributed unit, operate as a hierarchical parent to IAB relay nodes 104 and 106 (at hop order 1), which are parents of a child relay node 108 (at hop order 2) and so on. The donor node 102 is coupled via an F1 interface to a centralized unit (CU) 110 and the core 112. Note that FIG. 1 is only one example hierarchical IAB configuration, and, for example there can be a greater number or lesser number of hop orders and different numbers of parent and/or child nodes.

To act as an IAB link, each relay node is configured with a mobile UE function (alternatively referred to as an MT (mobile termination) function) and a gNB (gNodeB) or distributed unit (DU) function (IAB-DU). The MT function is used for communicating with the parent node(s), whereas the IAB-DU function is used for communicating with the child nodes and/or a UE 114 (or 116). The IAB-MT function and the IAB-DU function internally coordinate/communicate using a control plane interface (IAB-C).

As shown in the example of FIG. 1 via block 118, the technology described herein facilitates the communication of multifrequency-related data including multiplexing capability indication between nodes, from the child relay node 108 to the parent relay node 104 in this example. As described herein, the multifrequency-related data 118 can be used for configuration and coordination with one or more parent backhaul.

In various embodiments, the system 100 can be configured to provide and employ 5G wireless networking features and functionalities. With 5G networks that may use waveforms that split the bandwidth into several sub bands, different types of services can be accommodated in different sub bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

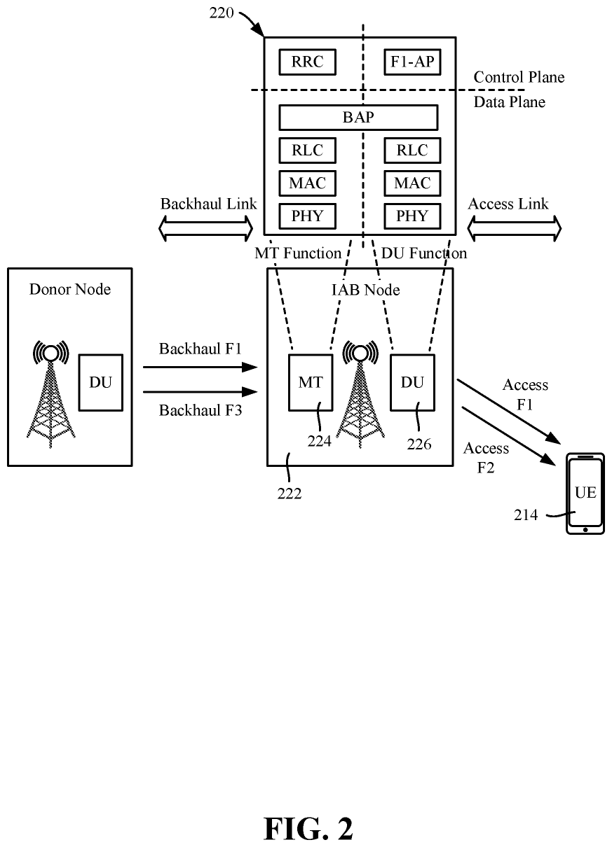

FIG. 2 illustrates an exemplary protocol stack structure 220 for an IAB node 222. If the backhaul links carrying relay traffic are based on the same channels and protocols as the access links carrying user data traffic then it is possible to construct the IAB node as containing two parallel protocol stacks, one containing a UE function (also called a mobile termination (MT) function, corresponding to block 224) which provides connectivity between the IAB node and a lower order IAB node or donor node which has a wired connection to the core network. The other IAB node functionality is the gNB function or distributed unit (DU) function (corresponding to block 226) which provides connectivity between the IAB node and a higher order IAB node or access UEs, e.g., the access UE 214.

As part of the IAB air interface higher layer protocols, in order to route the relay data traffic within the IAB node, in one example an adaptation layer (e.g., based on the backhaul adaptation protocol, or BAP) can be inserted above the radio link control (RLC) of both the MT and DU functions of the IAB node. In addition to data routing, the IAB node needs to manage the control plane signaling and configurations for both the MT and DU functions. As shown in FIG. 2, example of control plan signaling for the MT function involve radio resource control (RRC) and the F1-AP interface and Operations, Administration and Maintenance (OAM) for the DU function. This coordination can be performed internally in the IAB node by an IAB control (IAB-C) interface as shown in FIG. 1.

As part of the IAB air interface physical layer, the IAB nodes can multiplex the access and backhaul links in time, frequency, or space (e.g. beam-based operation) which includes the transmission of signals/channels utilized as part of initial access and measurements used for radio resource management. The same physical layer signals and channels used for these purposes by access UEs can be reused use for performing similar procedures at the IAB node.

As described herein, the IAB node 222 can perform multifrequency operation. An example of multifrequency IAB operation is also shown in FIG. 2. In this example, the IAB node 222 has its IAB-DU 226 operating two access links on carrier frequencies F1 and F2 respectively. Additionally, the IAB-MT 224 is operating two backhaul links on carrier frequencies F1 and F3 respectively.

This operation on F1 by both the IAB-MT and IAB-DU is representative of in-band IAB operation. The operation on F2 and F3 by the IAB-DU and IAB-MT respectively is representative of out-of-band IAB operation. In one implementation, an IAB node may operate in only in-band operation, only out-of-band operation, or both in-band and out-of-band operation simultaneously depending on the deployment scenario and IAB node capabilities. The frequencies F1, F2, and F3 may correspond to intra-band or inter-band operation (e.g. on separate component carriers) or may correspond to intra-carrier operation (e.g. on separate bandwidth parts or frequency partitions).

With respect to multifrequency capability coordination, one advantage of IAB is that backhaul and access are integrated and multiplexed in the scheduler, allowing dynamic resource allocation between the backhaul and access links (in both DL and UL directions). As a result, the duplex constraint at the relay is a factor when considering how to multiplex access and backhaul links. This consideration becomes more significant when supporting multiple hops of backhaul links, each with a similar duplex constraint. Specifically, the latency/overhead introduced by orthogonal partitioning of resources in either time or frequency needs to be considered. For mmWave frequencies, which are typically time division duplexing (TDD), a practical scenario for initial IAB deployments is to enforce a half-duplex constraint at the relay, wherein the nodes transmit on the access link and/or backhaul link at any given time.

This half-duplex constraint and the multi-hop topology of IAB, results in a staggered frame structure. In contrast, full-duplex IAB has decreased latency. For example, when the donor DU (hop 0) sends DL transmissions to the IAB node MT of hop order 1, said IAB node is receiving, hence it can schedule access UEs or child IAB nodes in the DL or UL. Alternatively, an IAB node MT of hop order 2 can transmit to the first order IAB node DU when the latter is receiving from the donor.

Both half-duplex and full-duplex operation may be relevant in case of multifrequency operation on the access and/or backhaul links of an IAB node. In one example, the operation on different frequency resources (e.g., different carriers or bands) may utilize separate hardware for an IAB-MT and IAB-DU function of an IAB node. Such hardware may include separate antenna panels, RF components, and baseband processing functionality. In another example, the operation on different frequency resources (e.g., different carriers or bands) may utilize shared or partially shared hardware for an IAB-MT and IAB-DU function of an IAB node. In the case of half-duplex operation, this may require TDM (time division multiplexing) between the IAB-MT and IAB-DU transmissions and receptions due to switching components or to avoid self-interference between the IAB-MT and IAB-DU transmissions and receptions. In the case of full-duplex operation, the IAB-MT and IAB-DU transmissions and receptions may be allowed simultaneously without restrictions, or may be only allowed in certain subsets of time/frequency/spatial resources based on certain IAB-node specific criteria (e.g. interference measurements, access versus backhaul traffic operation, supported timing modes, transmit power or dynamic range limitations, and/or beam management operation).

In one alternative, the indication of a given multiplexing capability (e.g. TDM/FDM (frequency division multiplexing)/SDM (space division multiplexing)/Full-Duplex) of the IAB node may be provided independently for each supported frequency carrier (e.g. F1/F2/F3) of an IAB-DU or IAB-MT. In a second alternative, the indication of a given multiplexing capability of the IAB node may be provided jointly for a given IAB-DU and IAB-MT for each supported frequency carrier (e.g. F1/F2/F3). In a third alternative, the indication of a given multiplexing capability of the IAB node may be provided jointly for a given supported IAB-DU frequency carrier and IAB-MT frequency carrier pair (e.g. {IAB-DU: F1, IAB-MT: F2}). The indication may be provided by F1-AP, RRC, BAP, MAC, or L1-based (e.g. DCI) signaling between a child IAB node and parent node and/or a donor node.

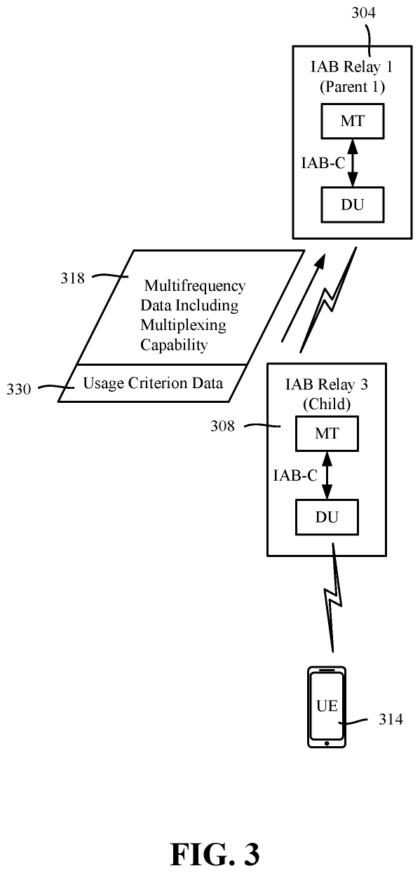

As shown in FIG. 3 via blocks 318 and 330, the signaling may also provide an indication (usage criterion data) of the criteria or restriction for using a given multiplexing capability on a given multifrequency carrier or set of carriers. More particularly, in addition to an indication of the multifrequency data/multiplexing capability of a child IAB node 308, criterion data, comprising a set of one or more conditions or restrictions that need to be met for the usage of a frequency resource and/or multiplexing capability, may be indicated to the donor and/or parent nodes (e.g., the node 604). Various non-limiting example alternatives are described herein.

For example, the criterion data indicating a contingent condition or restriction can be based on a supported timing alignment mode between a parent and child node; e.g., if not supported, then this frequency resource and/or multiplexing capability cannot be used. The criterion data indicating a condition or restriction can be based on a supported desired signal and/or interference measurement threshold being met, based on a configuration of a set of guard symbols or frequency resources between IAB-MT and/or IAB-DU transmission or reception opportunities, and/or can be recommended or restricted on a per-link basis, e.g. corresponding to a set of parent cell ID(s), component carriers or carrier groups, beams (e.g. based on SSB or CSI-RS (channel state information reference signal) indices), groups of beams, or antenna panels. The condition or restriction can be based on the IAB resource configuration, corresponding to contiguous or non-contiguous sets or subsets of time/frequency resources, and/or based on radio frequency (RF) hardware limitations (data), including but not limited to DL or UL transmit power, available power headroom, a power imbalance metric, dynamic range requirements, and/or adjacent channel leakage requirements. The condition or restriction can be based on link or channel type, including cell-specific configurations (e.g. STC/SMTC (SSB transmission configuration/SSB-based measurement timing configuration), RACH (random access channel(s), system information, periodic CSI-RS and so forth) of the IAB-MT or IAB-DU, or whether a given link or channel includes resources that are not used for access UE transmissions and are reserved for backhaul transmission and reception. Other alternatives and/or combinations of the above usage criterion are feasible.

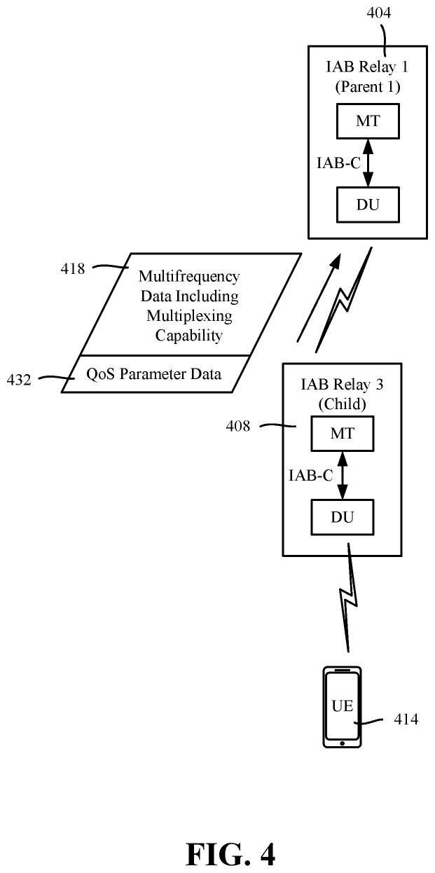

Turning to another aspect, to support efficient operation and enable backhauling of high priority or critical traffic, quality-of-service (QoS) can be applied for IAB operation on both access and backhaul links across multiple frequency bands in a RAN aware method (e.g. at the BAP layer or based on IAB node resource allocation). As shown in FIG. 4, QoS parameter data 432 can be appended to (or be part of) the multifrequency data signaling 418 sent from a child IAB node 408 to a parent IAB node 404.

In one alternative, QoS parameters may be applied per frequency carrier. In a second alternative, bearer mapping may be performed differently based on the frequency carrier. In a third alternative an IAB node may prioritize certain backhaul links over other backhaul links or access link traffic based on the frequency carrier used on the backhaul and/or access link. In a fourth alternative, in case of unlicensed operation on a given access and/or backhaul links, listen-before-talk (LBT) priority class or parameters (e.g. energy detect (ED) threshold, backoff, and the like) may be applied differently depending on the frequency carrier.

In a fifth alternative, the topology formation or metrics used for IAB node or user association may be configured and applied differently based on the frequency carrier. In one example the QoS is applied at the radio bearer level, (e.g. QoS class identifier (QCI) per frequency carrier). In another example the QoS is applied at the BAP layer (e.g. per backhaul RLC channel).

Thus, in the case of new radio (NR) traffic, QoS can be applied for IAB on both access and backhaul links across multiple frequency bands in a RAN aware method (e.g. at the BAP layer or based on IAB node resource allocation). However, non-NR-based traffic backhaul optimization is also available as described herein, (wherein “optimization” only represents an objective to move towards a more optimal state, rather than necessarily obtaining ideal results). More particularly, an IAB may also be utilized to backhaul non-NR based traffic (e.g. LTE traffic, Wi-Fi traffic, satellite traffic, operations and management traffic, etc.). In this case, QoS mechanisms for IAB may be enhanced to enable the non-NR based traffic sources to be aware of the multifrequency operation in order to potentially adapt and configure the backhaul operation.

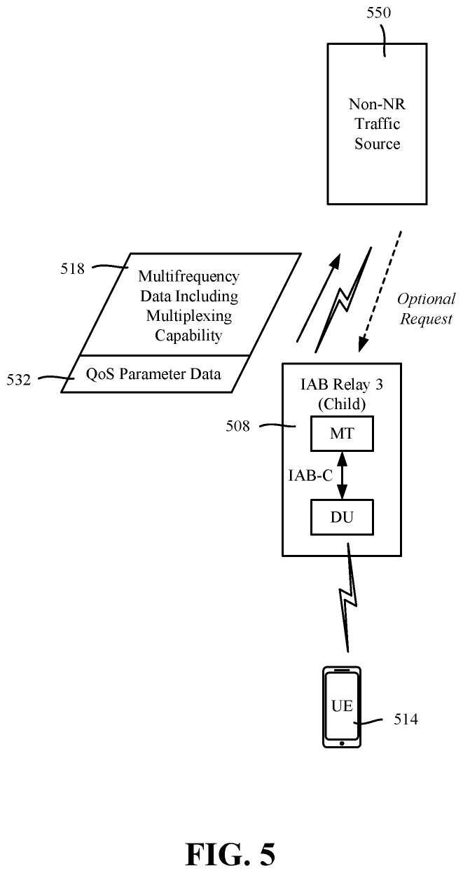

In one alternative, as shown in FIG. 5, the IAB node 508 may inform the non-NR based traffic source 550 of the multifrequency operation (block 518) via IP-based signaling, BAP-based signaling, OAM-based signaling, or radio-bearer based signaling depending on the implementation of the non-NR based traffic backhaul operation. The information may include, characteristics of the frequency carriers of the access and/or backhaul links, including bandwidth, supported data rate, L1/L2/L3 measurements (e g Channel Status Information (CSI), signal-to-noise and interference ratio (SINR), reference signal received power (RSRP), interference levels), number of supported or aggregated bearers, users, or data streams per frequency carrier, IAB topology information (e.g. number of hops per frequency layer), channel availability (e.g. in case of unlicensed operation on a backhaul and/or access link), and or supported QoS levels (e.g. QCI or backhaul RLC channel prioritization level), block 532.

In a second alternative, represented by the dashed arrow in FIG. 5, the non-NR based traffic source 550 may request multifrequency data 518 and QoS-related information 532 from the IAB node 508. In a third alternative, the non-NR based traffic source 550 may be provided multifrequency and QoS-related information from the IAB node 508 on-demand or periodically based on configured triggers (e.g. changes in one or more frequency carriers, measurements, or bearer configurations). In a fourth alternative, the non-NR based traffic source 550 may adapt and configure whether to backhaul traffic using IAB over a given frequency carrier(s) based on the provided multifrequency data 518 and QoS-related information 532. In a fifth alternative, the non-NR based traffic source 550 may adapt and configure whether to backhaul traffic using IAB over a given frequency carrier(s) based on the provided multifrequency data 518 and QoS-related information 532.

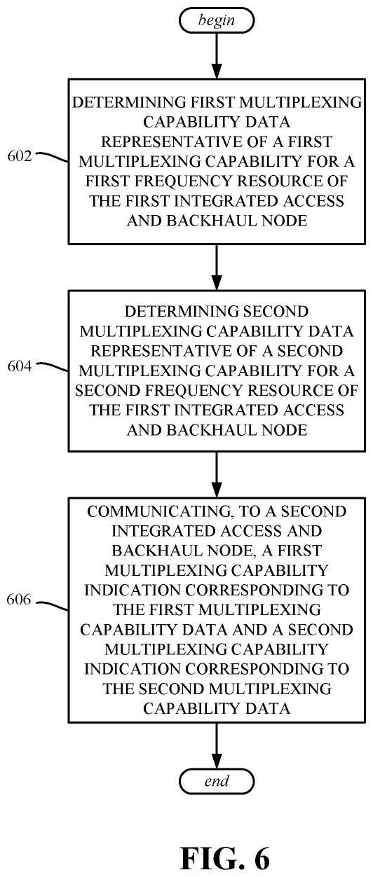

One or more aspects are represented in FIG. 6, and can comprise example operations, such as of a first integrated access and backhaul node, comprising a processor, and a memory that stores executable instructions which, when executed by the processor of the first integrated access and backhaul node, facilitate performance of operations. Operation 602 represents determining first multiplexing capability data representative of a first multiplexing capability for a first frequency resource of the first integrated access and backhaul node. Operation 604 represents determining second multiplexing capability data representative of a second multiplexing capability for a second frequency resource of the first integrated access and backhaul node. Operation 606 represents communicating, to a second integrated access and backhaul node, a first multiplexing capability indication corresponding to the first multiplexing capability data and a second multiplexing capability indication corresponding to the second multiplexing capability data.

Further operations can include determining third multiplexing capability data representative of a third multiplexing capability for a third frequency resource of the first integrated access and backhaul node, and communicating, to the second integrated access and backhaul node, a third multiplexing capability indication corresponding to the third multiplexing capability data.

The first integrated access and backhaul node can be a child node, and the second integrated access and backhaul node can be a parent node to the child node.

The second integrated access and backhaul node can be a donor node.

The first multiplexing capability for the first frequency resource of the first integrated access and backhaul node can be for a distributed unit function of the first integrated access and backhaul node, and can include at least one of: time division multiplexing, frequency division multiplexing, spatial division multiplexing or full duplex multiplexing.

The first multiplexing capability for the first frequency resource of the first integrated access and backhaul node can be for a mobile termination function of the first integrated access and backhaul node, and can include at least one of: time division multiplexing, frequency division multiplexing, spatial division multiplexing or full duplex multiplexing.

Further operations can include applying quality of service parameter data to new radio communications over the first frequency resource.

Further operations can include determining a first bearer mapping for communications over the first frequency resource, and determining a second bearer mapping for communications over the second frequency resource

Further operations can include prioritizing, by the first integrated access and backhaul node at least one of: backhaul link traffic of the first frequency resource over backhaul link traffic of the second frequency resource, or access link traffic of the first frequency resource over access link traffic of the second frequency resource.

Further operations can include determining at least one of: listen-before-talk priority class or listen-before-talk parameter data for communications over the first frequency resource.

Further operations can include determining a first topology formation for at least one of: the first integrated access and backhaul node or a user association for the first frequency resource, and determining a second topology formation for at least one of: the first integrated access and backhaul node or a user association for the second frequency resource

Further operations can include determining first metrics data for at least one of: the first integrated access and backhaul node or a user association for the first frequency resource, and determining second metrics data for at least one of: the first integrated access and backhaul node or a user association for the second frequency resource.

Further operations can include applying quality of service parameter data to non-new radio backhaul communications over the first frequency resource, and wherein the non-new radio backhaul communications are received from a non-new radio source.

Further operations can include providing at least one of: multifrequency-related information or quality of service-related information to a non-new radio source.

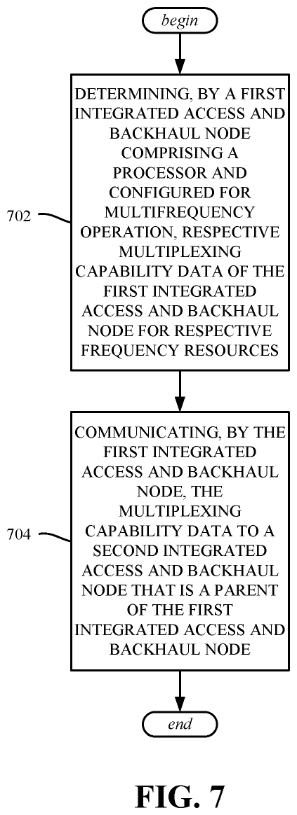

One or more aspects are represented in FIG. 7, and can comprise example operations, such as of a method, or a processor and a memory that stores executable instructions that, when executed by the processor, facilitate performance of the example operations, or a machine-readable medium, comprising executable instructions that, when executed by a processor, facilitate performance of the example operations. Operation 702 represents determining, by a first integrated access and backhaul node comprising a processor and configured for multifrequency operation, respective multiplexing capability data of the first integrated access and backhaul node for respective frequency resources. Operation 704 represents communicating, by the first integrated access and backhaul node, the multiplexing capability data to a second integrated access and backhaul node that is a parent of the first integrated access and backhaul node.

Further operations can include communicating, by the first integrated access and backhaul node, criterion data indicating contingent usage of the multiplexing capability data for a first frequency resource of the respective frequency resources.

Determining of the respective multiplexing capability data can include evaluating, for the respective frequency resources, at least one of: time resources, frequency resources or spatial resources.

Further operations can include prioritizing, by the first integrated access and backhaul node, communications over a first frequency resource of the respective frequency resources relative to a second frequency resource of the respective frequency resources.

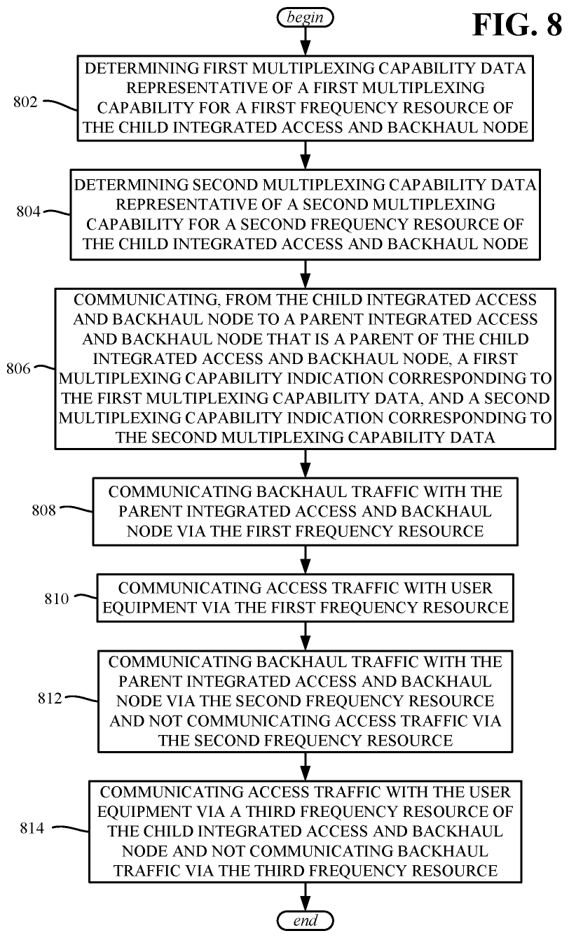

One or more aspects are represented in FIG. 8, and can comprise example operations, such as of a method, a processor and a memory that stores executable instructions that, when executed by the processor of a parent integrated access and backhaul node, facilitate performance of the example operations, or a machine-readable medium, comprising executable instructions that, when executed by a processor of a child integrated access and backhaul node, facilitate performance of operations. Operation 802 represents determining first multiplexing capability data representative of a first multiplexing capability for a first frequency resource of the child integrated access and backhaul node. Operation 804 represents determining second multiplexing capability data representative of a second multiplexing capability for a second frequency resource of the child integrated access and backhaul node. Operation 806 represents communicating, from the child integrated access and backhaul node to a parent integrated access and backhaul node that is a parent of the child integrated access and backhaul node, a first multiplexing capability indication corresponding to the first multiplexing capability data, and a second multiplexing capability indication corresponding to the second multiplexing capability data. Operation 808 represents communicating backhaul traffic with the parent integrated access and backhaul node via the first frequency resource. Operation 810 represents communicating access traffic with user equipment via the first frequency resource. Operation 812 represents communicating backhaul traffic with the parent integrated access and backhaul node via the second frequency resource and not communicating access traffic via the second frequency resource. Operation 814 represents communicating access traffic with the user equipment via a third frequency resource of the child integrated access and backhaul node and not communicating backhaul traffic via the third frequency resource.

Further operations can include applying quality of service parameter data to priority communications via the first frequency resource.

As can be seen, the technology described herein facilitates capability signaling between the network, parent IAB nodes, and child IAB nodes to provide more optimal multifrequency IAB network operation. The technology described herein allows QoS to be applied across multiple frequency carriers utilized by the IAB node for access and backhaul links. Further, the technology described herein supports awareness of multi-frequency operation outside of the RAN in case of non-NR based traffic backhauling

Turning to aspects in general, a wireless communication system can employ various cellular systems, technologies, and modulation schemes to facilitate wireless radio communications between devices (e.g., a UE and the network equipment). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc. For example, the system can operate in accordance with global system for mobile communications (GSM), universal mobile telecommunications service (UMTS), long term evolution (LTE), LTE frequency division duplexing (LTE FDD, LTE time division duplexing (TDD), high speed packet access (HSPA), code division multiple access (CDMA), wideband CDMA (WCMDA), CDMA2000, time division multiple access (TDMA), frequency division multiple access (FDMA), multi-carrier code division multiple access (MC-CDMA), single-carrier code division multiple access (SC-CDMA), single-carrier FDMA (SC-1-DMA), orthogonal frequency division multiplexing (OFDM), discrete Fourier transform spread OFDM (DFT-spread OFDM) single carrier FDMA (SC-FDMA), Filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM CP-OFDM, resource-block-filtered OFDM, Wi Fi, WLAN, WiMax, and the like. However, various features and functionalities of system are particularly described wherein the devices (e.g., the UEs and the network equipment) of the system are configured to communicate wireless signals using one or more multi carrier modulation schemes, wherein data symbols can be transmitted simultaneously over multiple frequency subcarriers (e.g., OFDM, CP-OFDM, DFT-spread OFDM, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, the system can be configured to provide and employ 5G wireless networking features and functionalities. With 5G networks that may use waveforms that split the bandwidth into several sub-bands, different types of services can be accommodated in different sub-bands with the most suitable waveform and numerology, leading to improved spectrum utilization for 5G networks. Notwithstanding, in the mmWave spectrum, the millimeter waves have shorter wavelengths relative to other communications waves, whereby mmWave signals can experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the third-generation partnership project (3GPP) and has been in use (including with LTE), is a multi-antenna technique that can improve the spectral efficiency of transmissions, thereby significantly boosting the overall data carrying capacity of wireless systems. The use of multiple-input multiple-output (MIMO) techniques can improve mmWave communications; MIMO can be used for achieving diversity gain, spatial multiplexing gain and beamforming gain.

Note that using multi-antennas does not always mean that MIMO is being used. For example, a configuration can have two downlink antennas, and these two antennas can be used in various ways. In addition to using the antennas in a 2×2 MIMO scheme, the two antennas can also be used in a diversity configuration rather than MIMO configuration. Even with multiple antennas, a particular scheme might only use one of the antennas (e.g., LTE specification's transmission mode 1, which uses a single transmission antenna and a single receive antenna). Or, only one antenna can be used, with various different multiplexing, precoding methods etc.

The MIMO technique uses a commonly known notation (M×N) to represent MIMO configuration in terms number of transmit (M) and receive antennas (N) on one end of the transmission system. The common MIMO configurations used for various technologies are: (2×1), (1×2), (2×2), (4×2), (8×2) and (2×4), (4×4), (8×4). The configurations represented by (2×1) and (1×2) are special cases of MIMO known as transmit diversity (or spatial diversity) and receive diversity. In addition to transmit diversity (or spatial diversity) and receive diversity, other techniques such as spatial multiplexing (comprising both open-loop and closed-loop), beamforming, and codebook-based precoding can also be used to address issues such as efficiency, interference, and range.

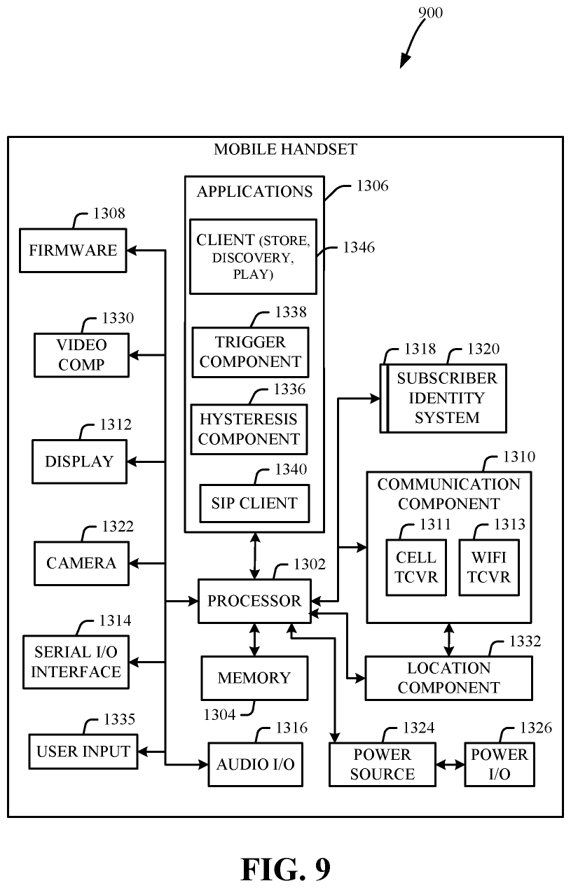

Referring now to FIG. 9, illustrated is a schematic block diagram of an example end-user device such as a user equipment) that can be a mobile device 900 capable of connecting to a network in accordance with some embodiments described herein. Although a mobile handset 900 is illustrated herein, it will be understood that other devices can be a mobile device, and that the mobile handset 900 is merely illustrated to provide context for the embodiments of the various embodiments described herein. The following discussion is intended to provide a brief, general description of an example of a suitable environment 900 in which the various embodiments can be implemented. While the description includes a general context of computer-executable instructions embodied on a machine-readable storage medium, those skilled in the art will recognize that the various embodiments also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can include computer storage media and communication media. Computer storage media can include volatile and/or non-volatile media, removable and/or non-removable media implemented in any method or technology for storage of information, such as computer-readable instructions, data structures, program modules or other data. Computer storage media can include, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The handset 900 includes a processor 902 for controlling and processing all onboard operations and functions. A memory 904 interfaces to the processor 902 for storage of data and one or more applications 906 (e.g., a video player software, user feedback component software, etc.). Other applications can include voice recognition of predetermined voice commands that facilitate initiation of the user feedback signals. The applications 906 can be stored in the memory 904 and/or in a firmware 908, and executed by the processor 902 from either or both the memory 904 or/and the firmware 908. The firmware 908 can also store startup code for execution in initializing the handset 900. A communications component 910 interfaces to the processor 902 to facilitate wired/wireless communication with external systems, e.g., cellular networks, VoIP networks, and so on. Here, the communications component 910 can also include a suitable cellular transceiver 911 (e.g., a GSM transceiver) and/or an unlicensed transceiver 913 (e.g., Wi-Fi, WiMax) for corresponding signal communications. The handset 900 can be a device such as a cellular telephone, a PDA with mobile communications capabilities, and messaging-centric devices. The communications component 910 also facilitates communications reception from terrestrial radio networks (e.g., broadcast), digital satellite radio networks, and Internet-based radio services networks.

The handset 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor 902 to facilitate wired and/or wireless serial communications (e.g., USB, and/or IEEE 994) through a hardwire connection, and other serial input devices (e.g., a keyboard, keypad, and mouse). This supports updating and troubleshooting the handset 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The handset 900 can include a slot interface 918 for accommodating a SIC (Subscriber Identity Component) in the form factor of a card Subscriber Identity Module (SIM) or universal SIM 920, and interfacing the SIM card 920 with the processor 902. However, it is to be appreciated that the SIM card 920 can be manufactured into the handset 900, and updated by downloading data and software.

The handset 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the handset 800 and IP-based multimedia content can be received in either an encoded or decoded format.

A video processing component 922 (e.g., a camera) can be provided for decoding encoded multimedia content. The video processing component 922 can aid in facilitating the generation, editing and sharing of video quotes. The handset 900 also includes a power source 924 in the form of batteries and/or an AC power subsystem, which power source 924 can interface to an external power system or charging equipment (not shown) by a power 110 component 926.

The handset 900 can also include a video component 930 for processing video content received and, for recording and transmitting video content. For example, the video component 930 can facilitate the generation, editing and sharing of video quotes. A location tracking component 932 facilitates geographically locating the handset 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 938 when the Wi-Fi transceiver 913 detects the beacon of the access point. A SIP client 940 enables the handset 900 to support SIP protocols and register the subscriber with the SIP registrar server. The applications 906 can also include a client 942 that provides at least the capability of discovery, play and store of multimedia content, for example, music.

The handset 900, as indicated above related to the communications component 810, includes an indoor network radio transceiver 913 (e.g., Wi-Fi transceiver). This function supports the indoor radio link, such as IEEE 802.11, for the dual-mode GSM handset 900. The handset 900 can accommodate at least satellite radio services through a handset that can combine wireless voice and digital radio chipsets into a single handheld device.

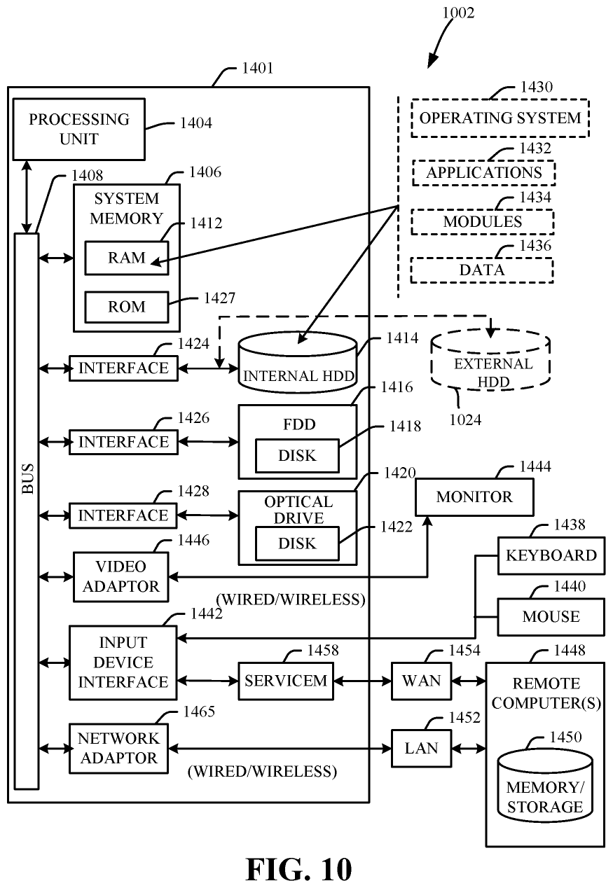

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD), non-volatile memory and other storage technology could be used in addition to, or in place of, an HDD 1014, and can be internal or external. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 994 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally include emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can include one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 994 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The computer is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 8 GHz radio bands, at an 10 Mbps (802.11b) or 84 Mbps (802.11a) data rate, for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. In addition, memory components or memory elements can be removable or stationary. Moreover, memory can be internal or external to a device or component, or removable or stationary. Memory can include various types of media that are readable by a computer, such as hard-disc drives, zip drives, magnetic cassettes, flash memory cards or other types of memory cards, cartridges, or the like.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to include, without being limited, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated example aspects of the embodiments. In this regard, it will also be recognized that the embodiments include a system as well as a computer-readable medium having computer-executable instructions for performing the acts and/or events of the various methods.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, solid state drive (SSD) or other solid-state storage technology, compact disk read only memory (CD ROM), digital versatile disk (DVD), Blu-ray disc or other optical disk storage, magnetic cassettes, magnetic tape, magnetic disk storage or other magnetic storage devices or other tangible and/or non-transitory media which can be used to store desired information.

In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communications media include wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

The above descriptions of various embodiments of the subject disclosure and corresponding figures and what is described in the Abstract, are described herein for illustrative purposes, and are not intended to be exhaustive or to limit the disclosed embodiments to the precise forms disclosed. It is to be understood that one of ordinary skill in the art may recognize that other embodiments having modifications, permutations, combinations, and additions can be implemented for performing the same, similar, alternative, or substitute functions of the disclosed subject matter, and are therefore considered within the scope of this disclosure. Therefore, the disclosed subject matter should not be limited to any single embodiment described herein, but rather should be construed in breadth and scope in accordance with the claims below.

What is claimed is:

1. A first integrated access and backhaul node, comprising:
a processor; and
a memory that stores executable instructions which, when executed by the processor of the first integrated access and backhaul node, facilitate performance of operations, the operations comprising:
determining first multiplexing capability data representative of a first multiplexing capability for a first frequency resource of the first integrated access and backhaul node;
determining second multiplexing capability data representative of a second multiplexing capability for a second frequency resource of the first integrated access and backhaul node; and
communicating, to a second integrated access and backhaul node, a first multiplexing capability indication corresponding to the first multiplexing capability data and a second multiplexing capability indication corresponding to the second multiplexing capability data.

2. The first integrated access and backhaul node of claim 1, wherein the operations further comprise determining third multiplexing capability data representative of a third multiplexing capability for a third frequency resource of the first integrated access and backhaul node, and communicating, to the second integrated access and backhaul node, a third multiplexing capability indication corresponding to the third multiplexing capability data.

3. The first integrated access and backhaul node of claim 1, wherein the first integrated access and backhaul node comprises a child node, and wherein the second integrated access and backhaul node comprises a parent node to the child node.

4. The first integrated access and backhaul node of claim 1, wherein the second integrated access and backhaul node comprises a donor node.

5. The first integrated access and backhaul node of claim 1, wherein the first multiplexing capability for the first frequency resource of the first integrated access and backhaul node is for a distributed unit function of the first integrated access and backhaul node, and comprises at least one of: time division multiplexing, frequency division multiplexing, spatial division multiplexing or full duplex multiplexing.

6. The first integrated access and backhaul node of claim 1, wherein the first multiplexing capability for the first frequency resource of the first integrated access and backhaul node is for a mobile termination function of the first integrated access and backhaul node, and comprises at least one of: time division multiplexing, frequency division multiplexing, spatial division multiplexing or full duplex multiplexing.

7. The first integrated access and backhaul node of claim 1, wherein the operations further comprise applying quality of service parameter data to new radio communications over the first frequency resource.

8. The first integrated access and backhaul node of claim 1, wherein the operations further comprise determining a first bearer mapping for communications over the first frequency resource, and determining a second bearer mapping for communications over the second frequency resource

9. The first integrated access and backhaul node of claim 1, wherein the operations further comprise, prioritizing, by the first integrated access and backhaul node at least one of: backhaul link traffic of the first frequency resource over backhaul link traffic of the second frequency resource, or access link traffic of the first frequency resource over access link traffic of the second frequency resource.

10. The first integrated access and backhaul node of claim 1, wherein the operations further comprise determining at least one of: listen-before-talk priority class or listen-before-talk parameter data for communications over the first frequency resource.

11. The first integrated access and backhaul node of claim 1, wherein the operations further comprise determining a first topology formation for at least one of: the first integrated access and backhaul node or a user association for the first frequency resource, and determining a second topology formation for at least one of: the first integrated access and backhaul node or a user association for the second frequency resource

12. The first integrated access and backhaul node of claim 1, wherein the operations further comprise determining first metrics data for at least one of: the first integrated access and backhaul node or a user association for the first frequency resource, and determining second metrics data for at least one of: the first integrated access and backhaul node or a user association for the second frequency resource.

13. The first integrated access and backhaul node of claim 1, wherein the operations further comprise applying quality of service parameter data to non-new radio backhaul communications over the first frequency resource, and wherein the non-new radio backhaul communications are received from a non-new radio source.

14. The first integrated access and backhaul node of claim 1, wherein the operations further comprise providing at least one of: multifrequency-related information or quality of service-related information to a non-new radio source.

15. A method, comprising:
determining, by a first integrated access and backhaul node comprising a processor and configured for multifrequency operation, respective multiplexing capability data of the first integrated access and backhaul node for respective frequency resources; and
communicating, by the first integrated access and backhaul node, the multiplexing capability data to a second integrated access and backhaul node that is a parent of the first integrated access and backhaul node.

16. The method of claim 15, further comprising communicating, by the first integrated access and backhaul node, criterion data indicating contingent usage of the multiplexing capability data for a first frequency resource of the respective frequency resources.

17. The method of claim 15, wherein the determining of the respective multiplexing capability data comprises evaluating, for the respective frequency resources, at least one of: time resources, frequency resources or spatial resources.

18. The method of claim 15, further comprising prioritizing, by the first integrated access and backhaul node, communications over a first frequency resource of the respective frequency resources relative to a second frequency resource of the respective frequency resources.

19. A non-transitory machine-readable medium, comprising executable instructions that, when executed by a processor of a child integrated access and backhaul node, facilitate performance of operations, the operations comprising:
determining first multiplexing capability data representative of a first multiplexing capability for a first frequency resource of the child integrated access and backhaul node;
determining second multiplexing capability data representative of a second multiplexing capability for a second frequency resource of the child integrated access and backhaul node;
communicating, from the child integrated access and backhaul node to a parent integrated access and backhaul node that is a parent of the child integrated access and backhaul node, a first multiplexing capability indication corresponding to the first multiplexing capability data, and a second multiplexing capability indication corresponding to the second multiplexing capability data;
communicating backhaul traffic with the parent integrated access and backhaul node via the first frequency resource;
communicating access traffic with user equipment via the first frequency resource;
communicating backhaul traffic with the parent integrated access and backhaul node via the second frequency resource and not communicating access traffic via the second frequency resource; and
communicating access traffic with the user equipment via a third frequency resource of the child integrated access and backhaul node and not communicating backhaul traffic via the third frequency resource.

20. The non-transitory machine-readable medium of claim 19, wherein the operations further comprise applying quality of service parameter data to priority communications via the first frequency resource.
